(19) United States
(12) Patent Application Publication
(10) Pub. No.: US 2020/0409362 A1
(43) Pub. Date: Dec. 31, 2020

(54) AUTONOMOUS DRIVING HANDOFF SYSTEMS AND METHODS

(71) Applicant: Byton North America Corporation, Santa Clara, CA (US)

(72) Inventors: Joseph William Long, San Diego, CA (US); Joseph Buczek, San Jose, CA (US)

(21) Appl. No.: 16/453,827

(22) Filed: Jun. 26, 2019

(51) Int. Cl. G05D 1/00; G05D 1/02; B60W 50/14; B60W 50/16

(52) U.S. Cl. CPC G05D 1/0088; G05D 1/0231; G05D 1/0257; B60K 6/22; B60W 50/16; B60W 2050/143; B60W 2050/146; B60W 50/14

(57) ABSTRACT

Disclosed is a method and apparatus for operating an autonomous vehicle. The method may include monitoring a functional load on a driver-assistance system of the autonomous vehicle as operation of the autonomous vehicle is being controlled by the driver-assistance system. The method may also include detecting when a current function load of the driver-assistance system satisfies a functional load threshold, and controlling operation of at least one component of the autonomous vehicle in response to detection of the functional load threshold being satisfied.

### FIELD

The disclosed embodiments relate generally to vehicle systems and in particular, but not exclusively, to enabling autonomous driving handoff.

### BACKGROUND

Vehicles, such as cars, trucks, trains, drones, etc., are integrating autonomous driving functions to control operation of the vehicles. For example, a car may be able to drive on a roadway, freeway, etc. without receiving input from a human operator. As another example, a train may be able to travel from one station to another station without input from a human conductor. Other autonomous vehicles may also perform operation autonomously without human intervention.

There are different levels of autonomous operation. For example, the Society of Automotive Engineers has divided autonomous driving capabilities into six levels ranging from level 0 having no automation and a human operator controls all aspects of a vehicles operation, to level 5 having full automation and a vehicle can operation on its own under any conditions that a human operator would be able to operate. Levels 3 and 4 are conditional and high levels of automation where a vehicle can manage most aspects of operation (e.g., controlling speed, braking, navigation, etc. in a car), and only prompt for driver input when a scenario is encountered that the vehicle cannot handle on its own. Determining when a vehicle cannot handle a specific scenario may be time sensitive, processing sensitive, or a combination of the two.

For example, U.S. Pat. No. 8,260,482 by Szybalski et al. uses regional location and existence of map data, as well as context, to determine whether driver-assistance system can competently control operation of an autonomous vehicle. Such a determination requires the detection of a specific context (e.g., location in a parking lot) or analyzing the sufficiency of mapping data to hand off control from an autonomous driving system to a human operator. Thus, if and when notification of a handoff is to occur may come as the detected context or insufficiency of map data is encountered, leaving little or insufficient time for the vehicle operator to take control of the vehicle. Furthermore, the identification of specific contexts of operation rely on a combination of training, visual perception, and decision making, which may not be able to account for new context or variation on existing contexts.

Some systems utilize specific context when autonomous operation can occur. For example, U.S. Patent Publication No. 2012/0277947 A1 to Boehringer et al. will perform autonomous driving when a specific scenario is encountered, such as a traffic jam. Then, the existence or non-existence of certain criteria, such as speed and distance to a moving object trigger warnings about the autonomous driving. As another example, in U.S. Patent Application Publication No. 2013/0211656 A1 to Kyoung-Hwan, et al., the reliability of a travel path is used to determine when to request a driver retake control of an autonomous vehicle. In both of the above examples, specific and defined factors are used to determine when to hand off autonomous driving from an autonomous driving system to a vehicle operator.

Therefore, the application of condition and high levels of autonomous driving may be limited to specific scenarios in which context, factors related to the context, etc. are known. Then handoff from the autonomous driving (e.g., from an autonomous driving system to a human operator) may also be subject to the ability of the autonomous driving system to detect specific changes to context, operating conditions, operating environment etc., which may fail to account for the innumerable variability in real world locations, road markings, pedestrian actions, traffic rules, etc. Furthermore, such variability can make such determinations difficult, time consuming, or even impossible.

### BRIEF DESCRIPTION OF THE DRAWINGS

FIG. 1 is a block diagram of an exemplary system architecture for performing autonomous driving handoff alert, warning, and remediation;

FIG. 2A is block diagram of one embodiment of a system including a vehicle for performing autonomous driving handoff warning and remediation;

FIG. 2B is block diagram of another embodiment of a system including a vehicle for performing autonomous driving handoff warning and remediation;

FIG. 3 is a flow diagram of one embodiment of a method for performing autonomous driving handoff warning and remediation;

FIG. 4 is a flow diagram of another embodiment of a method for performing autonomous driving handoff warning and remediation; and

FIGS. 5A-5C are block diagram of an exemplary dynamic scores for generating alerts and warnings in a vehicle operated in an autonomous mode.

### DETAILED DESCRIPTION

The word “exemplary” or “example” is used herein to mean “serving as an example, instance, or illustration.” Any aspect or embodiment described herein as “exemplary” or as an “example” in not necessarily to be construed as preferred or advantageous over other aspects or embodiments.

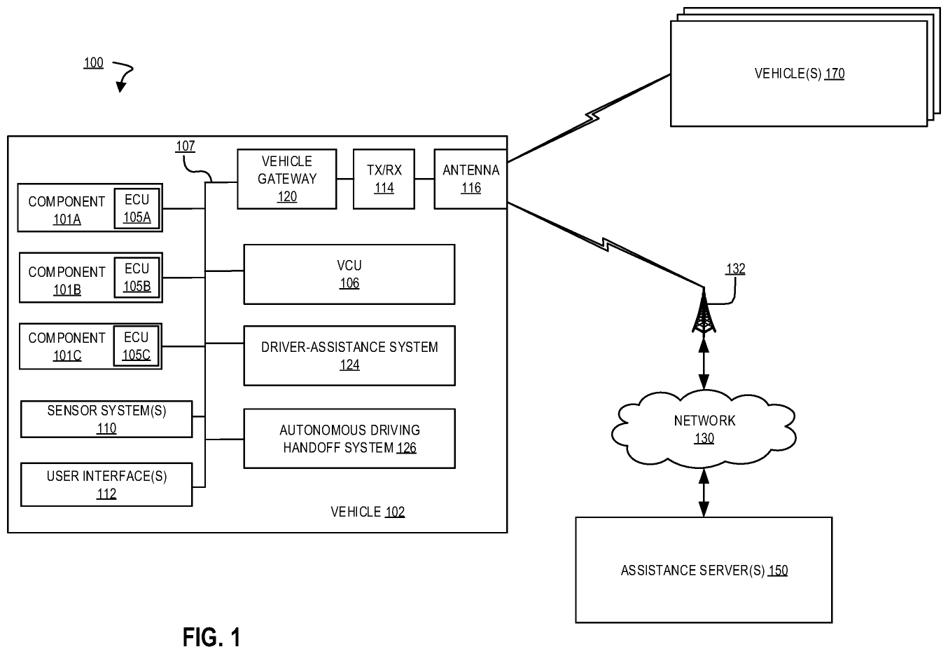

FIG. 1 is a block diagram of an exemplary system architecture 100 for performing autonomous driving handoff alert, warning, and remediation by a vehicle 102. In embodiments, vehicle 102 may be a fully electric vehicle, partially electric (i.e., hybrid) vehicles, non-electric vehicles (i.e., vehicle with a traditional internal combustion engine). Furthermore, although described mostly in the context of automobiles, the illustrated systems and methods can also be used in other wheeled vehicles such as trucks, motorcycles, electronic bicycles, buses, trains, etc. It can also be used in non-wheeled vehicles such as ships, airplanes (powered or gliders), drones, and rockets.

In embodiments, as discussed in greater detail herein, vehicle 102 is capable of operating in a fully and/or partial autonomous driving mode, such as for example in a Society of Automotive Engineers (SAE) level 3 or level 4 autonomous driving mode. Although SAE levels of autonomous operation of a vehicle are discussed herein as exemplary levels of autonomous driving capabilities, the embodiments of the present invention are not limited to operating according to these levels. Rather, alert, warning, and remediation techniques discussed herein are applicable to any vehicle where autonomous operation controls and manages most aspects of operating the vehicle (e.g., driving on a roadway, traveling on a railway, flying, etc.) without input or intervention of an operator, except in certain circumstances requiring intervention (e.g., an emergency, an unmapped or insufficiently mapped navigation environment, etc.). As will be discussed herein, it is in these circumstances where operator intervention is needed or desirable to take control of vehicle 102 from autonomous operation where embodiments of the present invention are used.

In embodiments, vehicle(s) 170 may also be a combination of fully electric vehicles, partially electric (i.e., hybrid) vehicles, non-electric vehicles, trucks, motorcycles, buses, trains, etc. In embodiments, one or more of vehicle(s) 170 share a roadway, railway, etc. with vehicle 102, and are capable of performing wireless communication with vehicle 102. For example, vehicle 102 and vehicle(s) 170 may communicate with one another to share position, traffic updates, weather updates, object recognition analysis results, as well as other real time or near real time information that may be relevant to vehicle 102 performing autonomous operation. Furthermore, there may exist network node(s) (not shown) that may be stationary and/or mobile devices, such as traffic lights, access points, etc. that are also capable of performing wireless communication with vehicle 102 to share additional data that may be used while vehicle 102 is operated in an autonomous driving mode.

In embodiments, assistance server(s) 150 are remote servers that provide assistance data relevant to one or more autonomous driving functions performed by vehicle 102, such as issuing traffic reports, weather advisories, updating map data, etc. Such assistance data may be provided by assistance server(s) 150 in real time or near real time to reflect a current operational environment of vehicle 102. Assistance server(s) 150 may be a single server computer system, or may be comprised of two or more server computer systems distributed over a network 130 (e.g., the Internet, a private network, or other network).

System 100 includes vehicle 102 communicatively coupled to any combination of vehicle(s) 170 and assistance server(s) 150. In the context of this application, “communicatively coupled” means coupled in such a way that data can be exchanged, in one or both directions, between two entities or components (e.g., between the vehicle 102 and vehicle(s) 170, and assistance server(s) 150) using standard and/or proprietary protocols for the exchange of information.

In one embodiment, vehicle 102 includes one or more systems, such as components 101 each having an electronic control unit (ECU) 105, and each ECU 105 is communicatively coupled via a communications network 107 to a vehicle control unit (VCU) 106. The communications network 107 may be a controller area network (CAN), an Ethernet network, a wireless communications network, another type of communications network, or a combination of different communication networks. VCU 106 is also communicatively coupled to a plurality of sensor system(s) 110 (e.g., a positioning system, a radio detection and ranging (RADAR) system, a light detection and ranging (LIDAR) system, an imaging system having one or more cameras that captures two-dimensional and/or three-dimensional image data, a sound navigation and ranging (SONAR) system, proximity sensors, weather sensors, light sensors, noise sensors, etc.), a user interface 112, a driver-assistance system 124 that performs autonomous control of vehicle 102 according to the data captured by sensor system(s) 110, and an autonomous driving handoff system 125 that warns an operator and/or controls one or more autonomous preventative actions in real or near-real time based on the surroundings and other operating conditions experienced by vehicle 102.

Components 101 are generally components of the systems of the vehicle 102. For example, components 101 can include adjustable seat actuators, power inverters, window controls, etc. Components 101 may also include automated driving system controllers, such as a braking assistance systems, adaptive headlight control systems, adaptive cruise control system, cornering brake assist systems, navigation system, autopilot systems, etc.

Vehicle control unit (VCU) 106 is a controller including a microprocessor, memory, storage, and a communication interface with which it can communicate with components 101, sensor system(s) 110, user interface(s) 112, driver assistance system 124, autonomous driving handoff system 126, and transceiver 114 via network 107. In one embodiment VCU 106 is the vehicle's 102 main computer, but in other embodiments it can be a processing component separate from the vehicle's main or primary computer.

In one embodiment, vehicle 107 includes vehicle gateway 120. Vehicle gateway 120 is a networking appliance that resides on vehicles communications network 107. Vehicle gateway 120 may include a network interface, processor, memory, and one or more processing modules. In one embodiment, vehicle gateway 120 may reside in VCU 106, as well as in other components with sufficient access to network 107, processing power, and memory resources to perform the operations described in greater detail herein.

In embodiments, vehicle gateway 120 may be a hardware security module that provides a secure computing and storage environment, which is isolated from other processing and memory of vehicle 102. For example, vehicle gateway 120 may perform processes such as broadcasting for new network connections, establishing secure network connections with network nodes (e.g., one or more of vehicle(s) 170 and assistance server(s) 150), performing encryption of network communications, exchanging information with network nodes, negotiating wireless connection parameters, etc.

In embodiments, driver-assistance system 124 controls one or more components 101 to perform autonomous operation of vehicle 102. In embodiments, for example where vehicle 102 is a motor vehicle driving on a roadway, this can include driver-assistance system 124 controlling speed, lane maintenance, lane changes, braking, navigation, obeying traffic laws, controlling vehicle trajectory relative to other vehicles, as well as other autonomous operations that control operation of vehicle 102 on a roadway. In embodiments, driver-assistance system 124 utilizes sensor data from the one or more sensor system(s) 110 to analyze the operating environment of vehicle 102. For example, the sensor data may enable driver-assistance system 124 to detect and track relative speed, course, trajectory, etc. of surrounding vehicles, determine weather conditions, detect road conditions, capture two-dimensional and/or three-dimensional imaging data of vehicle's 102 surroundings, perform image recognition on the image data to determine content of street signs, traffic signs, roadway condition signs, construction signs, perform image recognition on the image data to identify and track pedestrians, other vehicles, stationary objects such as traffic signs, or obstacles, as well as many other data capture and recognition processes that identity and model the surrounding operational environment of vehicle 102. The detailed analysis of the surrounding operational environment enables driver-assistance system 124 to autonomously (e.g., without operator intervention) control operation of the motor vehicle to, for example, drive along a roadway without operator intervention. Such autonomous control is a computationally intensive process, and requires the concurrent analysis of a plurality of different yet interrelated factors.

In embodiments, the driver-assistance system 124 may not provide full automation (e.g., provides SAE level 3 or level 4 autonomous operation capabilities). That is, there may be scenarios that require operator intervention to take over control of the vehicle's 102 operation from driver-assistance system 124. Examples of such scenarios include: incomplete sensor data that does not enable driver-assistance system to generate a sufficient model of vehicle's 102 surroundings, a scenario is encountered by vehicle 102 that driver-assistance system does not recognize or cannot react to, or vehicle processor overload that does not enable driver-assistance system 124 to perform adequate operational environment analysis. Such scenarios may be the result of dangerous, sudden, unpredictable, etc. conditions in the operational environment of vehicle 102 (e.g., a pedestrian making an unpredictable movement into a lane of traffic, a heavy rain limiting the effectiveness of one or more of sensor system(s) 110, a sporadic and/or unpredictable vehicle being encountered, entering a real world location with incomplete map data, encountering a section of roadway under construction and without traffic lines, a malfunctioning sensor that provides erroneous sensor readings and/or stops providing sensor readings, etc.). The functional load of the analysis of the operational environment by the driver-assistance system 124 as the complexity of the environment increases may make detection of one or more of the conditions requiring operator intervention difficult to detect and/or time consuming, thereby leading to insufficient notice and/or warning provided to the vehicle's operator. When this occurs, there may be little or no warning provided to an operator of the vehicle that would otherwise enable the operator to take control of the vehicle. Furthermore, the time before an obstacle or operating condition that requires user intervention (e.g., a period of forewarning) may not be sufficient to enable the operator to appropriately respond to the encountered obstacle or operating condition when the proper detection of such obstacle or operating conditions can be delayed due to the heavy functional load placed on the driver-assistance system 124 by the complex operational environment.

For example, the driver-assistance system 124 may detect, analyze, track, and model a plurality of operational conditions (e.g., position, speed, acceleration, and trajectory of each of a plurality of nearby vehicles, position, speed, acceleration, and trajectory of detected pedestrian, positioning performed for vehicle's 102 current position, analysis of map data based on position, adjusting traffic and/or tracking analysis based on sensed and/or received weather data, receiving wireless traffic, roadway, or other alerts from nearby vehicles, network nodes, assistance servers, etc.). From the results of the detection, analysis, tracking, and/or modeling, driver-assistance system 124 determines how to autonomously control operation of the vehicle (e.g., control a speed and trajectory of vehicle 102 that maintains acceptable distances from nearby vehicles, obeys traffic laws, navigates vehicle to a destination, etc.). However, as the complexity of the analysis performed by driver-assistance system 124 increases, it may become more difficult to detect and track developing and/or imminent conditions that may require the operator to take control of vehicle 102, and may lead to delays in generating alerts, warnings, and remediative actions that enable the operator and/or driver-assistance system 124 to respond to the developing and/or imminent conditions.

In embodiments, autonomous driving handoff system 126 may generate one or more alerts and/or warnings that enable an operator of vehicle 102 to take over control of vehicle 102 from the driver-assistance system 124. Furthermore, autonomous driving handoff system 126 may further adjust one or more settings of the driver-assistance system 124 or automated driving system controller(s) (e.g., cruise control, braking, lighting, etc. systems) to control operation of vehicle 102 based on the functional load experienced by driver-assistance system 124. As will be discussed in greater detail herein, autonomous driving handoff system 126 detects and/or monitors the computational tasks being performed by driver-assistance system 124. In embodiments, the tasks are those that enable driver-assistance system 124 to perform autonomous control and operation of vehicle 102, such as object detection, object identification, object tracking, object trajectory prediction, navigation, etc. Since driver-assistance system 124 is executed by a processing system (e.g., as part of VCU 106, as part of its own processing system, etc.), each computational task acts as a measure of a functional load placed on the driver-assistance system 124. In embodiments, the total of the individual functional loads of the autonomous driving tasks as the driver-assistance system 124 performs operations in an operational environment is therefore a measure of the current functional load experienced by the driver-assistance system 124. This measure is dynamic and fluctuates in real time as the operational environment of vehicle 102 changes (e.g., based on changes in roadway, number of nearby vehicles, pedestrians, weather changes, a transition to low light conditions, etc.).

In one embodiment, autonomous driving handoff system 126 interfaces with driver-assistance system 124 to monitor and measure each of the tasks being performed by driver-assistance system 124. For example, autonomous driving handoff system 126 may detect processing threads being initiated and terminated where driver-assistance system 124 operations in a multi-threaded computational environment, type and priority of a task being performed, a percentage computational load exerted by a task on processing resources, etc. In one embodiment, autonomous driving handoff system 126 may use the monitoring of tasks being executed by driver-assistance system 124 to generate a current measure of functional load placed on the processing resources of vehicle 102 (e.g., on the VCU 106 or other processing resources used to execute the driver-assistance system 124). In embodiments, that measure may be based on a total number of computation tasks currently being executed by driver-assistance system 124. Furthermore, the measure may be adjusted to reflect complexity or resources of individual tasks (e.g., weighting certain tasks), adjusted to reflect a priority given to individual tasks (e.g., detection and tracking of pedestrians may be weighted to reflect importance), etc.

Autonomous driving handoff system 126 may then analyze the measure of current functional load experienced by driver-assistance system 124 with respect to one or more functional load thresholds. In one embodiment, one or more thresholds may be established by autonomous driving handoff system 126 based on availability of processing resources to the driver-assistance system 124 (e.g., based on processor type(s) that executes driver-assistance system 124, based on processor speeds, based on memory available to that processor, based on how many multi-threaded operations may be executed in parallel, etc.). For example, a first threshold may be associated with a first level of usage of processing resources (e.g., 50% usage), and a second threshold may be associated with a second and greater level of usage of processing resources (e.g., 70%). In embodiments, the thresholds may be associated with alerts given to an operator of vehicle using a first set of user interface elements (e.g., graphical user interface alerts, haptic feedback alerts, auditory alerts, etc.) when the first threshold is satisfied (e.g., 50% of processing resources are currently being consumed by the driver assistance system 124 to operate vehicle 102), warnings given to an operator of the vehicle using a second set of user interface elements (e.g., more prominently or centrally displayed graphical user interface warnings, stronger haptic feedback, auditory alerts with increased volume, different tones, etc.), and remediative actions taken by the autonomous driving handoff system (e.g., changing settings of the driver-assistance system 124 or components 101 to control speed, trajectory, braking, or other autonomous functions) to control operation of the vehicle 102 in response to the first, second, and/or additional thresholds being satisfied.

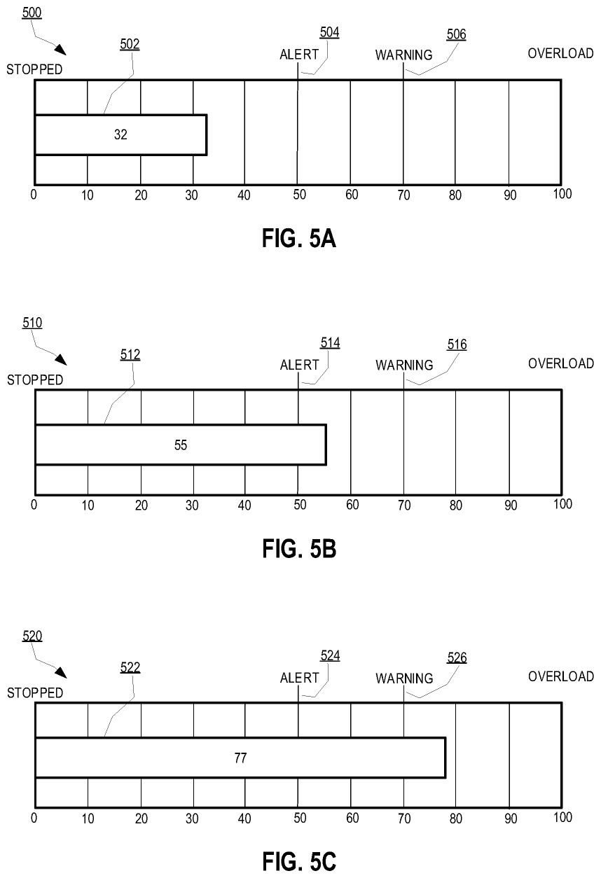

For example, the first threshold may be associated with a functional load indicating a first level of complexity of the operational environment in which vehicle 102 is currently located, while the second threshold may be associated with a second level of complexity of the operational environment. The current functional load placed on processing resources available to the driver-assistance system 124, as discussed herein, may be based on a total number of tasks being performed, and any adjustments to tasks (e.g., weighting specific tasks based on priority, computational requirements of the task, type of task, etc.). Thus, the current functional load as measured by autonomous driving handoff system 126 can be analyzed with reference to the first and second thresholds to determine when to, for example issue alerts, warning, and changes to the autonomous operation of vehicle 102. For example, FIG. 5A diagrammatically illustrates a scale 500 for measuring a percentage of a current functional load 502 placed by driver-assistance system 124 on processing resources available to driver-assistance system 124. The scale 500 is illustrated as ranging from zero (e.g., when the vehicle is stopped and/or not using autonomous controls) to one hundred percent usage (e.g., when the driver-assistance system 124 is overloading the available processing resources and will cease functioning properly). As illustrated the current functional load 502 is 32% in an operational environment where the vehicle is performing highway driving, it is sunlit, pavement is dry, and there are only 3 nearby vehicles, which does not satisfy an alert threshold 504 or warning threshold 506. With different operational conditions, such as highway driving, in the dark, with wet pavement, and 7 nearby cars as illustrated by the current functional load 512 of 55% illustrated in FIG. 5B, an alert threshold 514 is satisfied while a warning threshold 516 Is not satisfied. With still different operational conditions, such as urban street driving, with sunlit conditions, dry pavement, five pedestrians, the current functional load 522 of 77% may satisfy both an alert threshold 524 and a warning threshold 526, as illustrated in FIG. 5C. As discussed herein, different alerts and warnings may be issued in response to detection by autonomous driving handoff system 126 when certain thresholds are satisfied. The scales, thresholds, operational conditions, and functional loads illustrated in FIGS. 5A-5C are merely examples, as different measures of functional load, different and/or additional thresholds (e.g., user specific thresholds, learned thresholds, environmentally adjusted thresholds, etc.), different and/or additional operational conditions than those referenced in FIGS. 5A-5C, etc. may be used and experienced by vehicle 102 in accordance with the discussion herein.

As discussed herein, the detected satisfaction of the alert threshold (e.g., 504, 514, and 524) may cause autonomous driving handoff system to issue a set of one or more GUI, haptic, auditory or other alert(s) to user interface(s) 112 indicating that an operator of vehicle 102 may (in the future) need to take over control of vehicle 102 from the driver-assistance system 124. Furthermore, the detected satisfaction of the warning threshold (e.g., 506, 516, and 526) may cause autonomous driving handoff system to issue a different set of one or more GUI, haptic, auditory or other warning(s) to user interface(s) 112 indicating that an operator of vehicle 102 should immediately take over control of vehicle 102 from the driver-assistance system 124. For example the detected satisfaction of the second, warning threshold may be indicative of an operational environment in which the driver-assistance system 124 is unable to operate, or in which a human operator would be safer than the driver-assistance system 124. Thus, the satisfaction of the second threshold may result in GUI, haptic, auditory, or other warning(s) displayed more prominently in a display of vehicle 102, a louder auditory signal, an auditory signal with a different tone or cadence, more intense haptic feedback, etc.

Furthermore, in embodiments, autonomous driving handoff system 126 may further issue one or more commands to control and/or adjust one or more systems of vehicle 102 based on the detected satisfaction of the one or more functional load thresholds. For example, autonomous driving handoff system 126 may adjust one or more autonomous driving settings currently being used by driver-assistance system 124 to control operation of vehicle to place more distance between vehicle 102 and vehicle(s) 170, change a navigation route, pull off a roadway, etc. As another example, autonomous driving handoff system 126 may issue commands to adjust operation of one or more automated driving systems (e.g., automatic braking, lane assist systems, cruise control systems, etc.). Furthermore, these operations are adjusted and controlled by autonomous driving handoff system 126 in real time or near real time due to the continuous monitoring of the operational environment, the functional load placed on processing resources by driver-assistance system, as well as other operating factors.

In embodiments, autonomous driving handoff system 126 monitors additional factors that may be associated with handoff alert and warning notifications. In one embodiment, autonomous driving handoff system 126 may additionally monitor systems of vehicle 102 that are used for autonomous driving, such as camera systems, LIDAR systems, VCU 206, etc. Autonomous driving handoff system 126 may, in embodiments, be a processing system communicatively coupled with a communications bus of vehicle 102, and therefore monitors and/or interfaces with the systems of vehicle 102 that are used for autonomous driving. In embodiments, autonomous driving handoff system 126 may monitor each such system, critical and/or used for performing autonomous driving, for system health factors including timing of messages reporting data and/or status, coherency between measurements over time, whether a power cycle has occurred, whether the system is still located on the network (e.g., has it died or lost its connection), as well as other factors that would impact the performance of such systems, and thus autonomous driving capabilities of vehicle 102.

According to the embodiments discussed herein, autonomous driving handoff system 126 performs a less computationally complex process to determine when alerts and/or warnings should be issued to vehicle operators than the processes performed by driver-assistance system 124 to detect, identify, track, and then warn of such circumstances requiring autonomous driving handoff to an operator. That is, for example, functional load monitoring and measurement enables autonomous driving handoff system 126 to detect when to issue alerts and/or warnings in a way that is not subject to unpredictable and overly complex environments (e.g., those in which driver-assistance is not trained or unable to operate in). Furthermore, specific conditions in an operating environment are not necessarily the trigger for a notification, and instead functional load measurement is able to offer alerts and/or warnings to be issued sooner and with minimal impact on the processing resources used by driver-assistance system 124. For example, autonomous driving handoff system 126 need not detect, track, and predict the actions of a pedestrian, who may be inherently unpredictable, to determine whether to issue alerts, warnings, take remediative actions, etc. based on the actions of the pedestrian. Instead, autonomous driving handoff system 126 tracks a measure of overall functional load of the current operational environment. Such functional load can be measured, as discussed herein, based on the utilization of processing resources, number of tasks being performed, etc. by the driver-assistance system 124. The determination and usage of functional load placed on processing resources by driver-assistance system 124 is also a low processing and memory utilization process, therefore preserving more processing and memory resources for other processes of the driver-assistance system 124. Additionally, the analysis of health factors associated with vehicle systems critical to the proper functioning of autonomous driving aids in the alerting and/or warning of driver, especially when such sensor system health factors do not necessarily increase function load on processing resources.

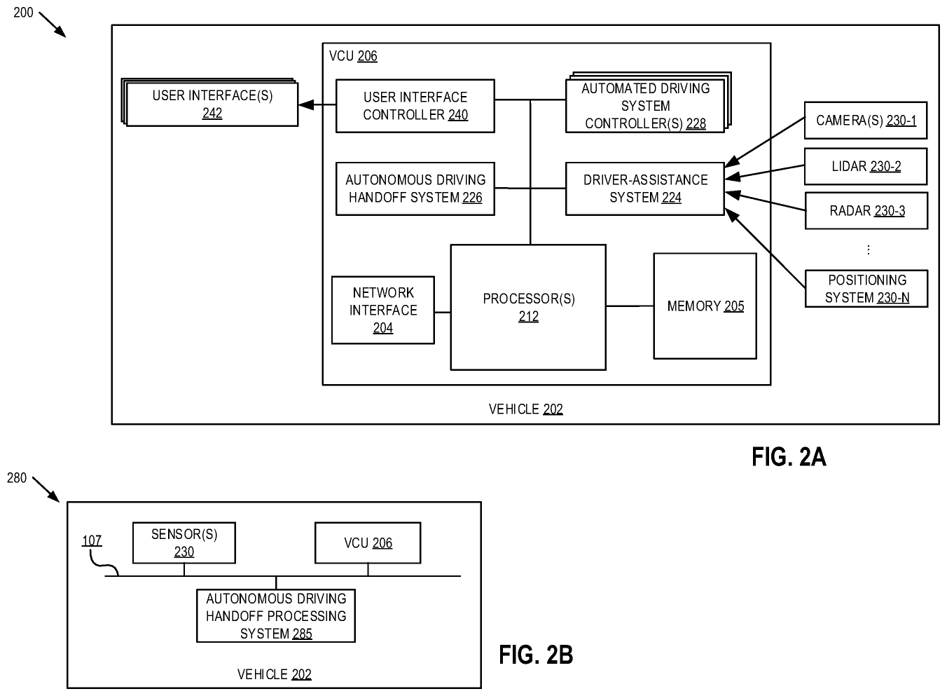

FIG. 2A is block diagram of one embodiment of a system 200 including a vehicle 202. Vehicle 202 provides additional details for vehicle 102 discussed above in FIG. 1.

In one embodiment, vehicle 202 is a system, which may include one or more processor(s) 212, a memory 205, and a network interface 204. It should be appreciated that vehicle 202 may also include, although not illustrated, a user and/or hardware interface, vehicle controls, one or more power device(s) (e.g., vehicle battery), drive control system, one or more vehicle systems (e.g., VCUs, components, positioning systems, etc.), a propulsion system (e.g. an electric, gasoline, natural gas, hybrid, etc. powered motor), a steering system, a braking system, as well as other components typically associated with vehicles. Although only a single network interface 204 is illustrated, it is understood that network interface 204 may be capable of communicatively coupling vehicle 202 to any number of other vehicles (e.g. vehicle(s) 170) and/or remote servers (e.g., assistance server(s)) using one or more wireless subsystems (e.g., Bluetooth, WiFi, Cellular, or other networks) to transmit and receive data streams through one or more communication links.

In embodiments, memory 205 of vehicle 202 may be coupled to processor(s) to store instructions for execution by one or more processors, such as processor(s) 212. In some embodiments, the memory is non-transitory, and may store one or more processing modules. In one embodiment, memory 205 of vehicle 202 may store one or more processing modules, such as a driver-assistance system 224, an autonomous driving handoff system 226, a user interface controller 240, and automated driving system controller(s) 228 to implement embodiments described herein.

It should be appreciated that the embodiments as described herein may be implemented through the execution of instructions, for example as stored in memory or other element, by processor(s) 212 and/or other circuitry of vehicle 202. Particularly, circuitry of vehicle 202, including but not limited to processor(s) 212, may operate under the control of a program, routine, or the execution of instructions to execute methods or processes in accordance with the aspects and features described herein. For example, such a program may be implemented in firmware or software (e.g. stored in memory 205) and may be implemented by processor(s) 212, and/or other circuitry. Further, it should be appreciated that the terms processor, microprocessor, circuitry, controller, engine, manager, generator, etc., may refer to any type of logic or circuitry capable of executing logic, commands, instructions, software, firmware, functionality and the like.

Further, it should be appreciated that some or all of the functions, engines, modules, controller, systems, etc. described herein may be performed by vehicle 202 itself and/or some or all of the functions, engines or modules described herein may be performed by another system connected through network interface 204 to vehicle 202. Thus, some and/or all of the functions may be performed by another system, and the results or intermediate calculations may be transferred back to vehicle 202. In some embodiments, such other system may comprise a server (not shown).

In one embodiment, vehicle 202 includes a plurality of sensor, such as camera(s) 230-1 to capture two-dimensional and/or three-dimensional image data of vehicle's 202 surroundings, a LIDAR system 230-2 and/or RADAR system 230-3 to perform ranging and object detection of objects proximate to vehicle 202, positioning system 230-N that provides global navigation satellite system based real world positioning data, as well as other sensors (e.g., light, temperature, weather, proximity, etc.). The data gathered by the sensors is provided to the driver-assistance system 224.

As discussed herein, driver-assistance system 224 ingests and analyzes the sensor data to perform on or more autonomous driving tasks, such as object detection, recognition, and tracking for objects within the operational environment surrounding vehicle 202. In embodiments, driver-assistance system 224 may implement one or more machine learning based techniques for the object detection, recognition, and tracking. Based on the object detection, recognition, and tracking, driver-assistance system 224 may determine autonomous driving operations that will autonomously control vehicle 202. For example, the autonomous driving operations enable driver-assistance system 224 to implement SAE level 3 and/or level 4 autonomous driving.

Driver assistance system 224 issues commands to implement the determined autonomous driving controls to one or more automated driving system controller(s) 228. The automated driving system controller(s) 228 directly control, for example, steering systems, braking systems, acceleration systems, light systems, cruise control systems, etc. of vehicle 202.

In one embodiment, while driver-assistance system 224 is performing autonomous control of the operation of vehicle 202, autonomous driving handoff system 226 interfaces with driver-assistance system 224. In one embodiment, the interfacing is through an application programming interface (API) of driver-assistance system 224 that exposes one or more operations of driver-assistance system to outside systems (e.g., autonomous driving handoff system 226). As discussed herein, autonomous driving handoff system 226 interfaces with driver-assistance system 224 via the APIs to monitor computational tasks being performed by driver-assistance system 224. For example, autonomous driving handoff system 226 may detect the creation of new tasks, the completion of tasks, the state of a multi-threaded execution environment (e.g., task queuing, pipeline congestion, resource utilizing percentage, etc.), types of tasks and how they may weight a specific task's measure, etc. In embodiments, the detection may include the autonomous driving handoff system 226 utilizing the API of the driver-assistance system 224 to monitor the functional and/or operational tasks and conditions of the driver-assistance system (e.g., monitor current processor utilization). In embodiments, autonomous driving handoff system 226 may further receive API based messaging generated by the driver-assistance system including reports on processing utilization, number of tasks, etc. In embodiments, the monitoring and messaging may be used for comparison with known characteristics of the processing resources available to the driver-assistance system 224 (e.g., known processor speed, number of tasks supported in a multi-threaded and parallel processing environment, current processor usage tracked by an operating system kernel executing the driver-assistance system, etc.).

In embodiments, autonomous driving handoff system 226 uses the task monitoring to generate a measure of a current functional load of driver-assistance system 224 on the processing resources available to driver-assistance system 224. In embodiments, a measure, such as a central processing unit utilization generated by the operating system executing the driver-assistance system 224, may establish the current functional load of the driver-assistance system 224. That is, the CPU utilization percentage would be indicative of total resources being consumed and/or available for performing driver-assistance system 224 tasks. In another embodiment, a weighted combination of factors could be utilized, such as w₁*f₁+w₂*f₂+ . . . +wₙfₙ, where wᵢ is a programmatic and/or developer specified weight given to a specific processing resource utilization factor fᵢ, and where the total is compared to a scale associated with a maximum for allowable processing resource utilization. For example, autonomous driving handoff system 226 may measure the current functional load of driver-assistance system 224 based on a total number of tasks being executed by driver-assistance system 224 to perform autonomous operation of vehicle 202 in view of the total possible number of concurrent tasks the processing environment is capable of processing. As another example, autonomous driving handoff system 226 may measure factors effecting current functional load, such as the tracking types of tasks, thread congestion, pipeline queuing etc., which are either monitorable system performance characteristics exposed to the autonomous driving handoff system 226 by the API of the driver-assistance system, or communicated to the autonomous driving handoff system 226 in messages generated by the driver-assistance system 224. Furthermore, individual measures may be adjusted or weighted based on task type (e.g., weighting pedestrian tracking greater than stationary object tracking), based on operational environment factors (e.g., weighting all tasks greater in rainy conditions than sunny conditions), based on driver (e.g., when driver is known, driver settings, driver characteristics, etc. can cause weighting of tasks, such as weighting tasks for an inexperienced driver and not weighting tasks for an experienced driver), as well as other factors. In embodiments, such weighting may be set programmatically for specific tasks, computational conditions, etc. through API based messaging from the driver-assistance system 224 to the autonomous driving handoff system (e.g., to enable a developer of the specific driver-assistance system to set weighting for tasks, operational conditions, etc. for specific driver-assistance systems), weighting may be set according to drive modes of the vehicle (e.g., certain tasks associated with weather condition processes may be weighted differently when traction control functions of the vehicle are being used, certain tasks associated with vehicle trajectory and spacing may be weighted greater or lower based on driver experience characteristics, etc.), weighting may be adjusted and/or readjusted dynamically during operation based on messages generated by the driver-assistance system 224 in response to changes in environment (e.g., changes in type of roadway such as residential or freeway, changes in surrounding objects including detection of pedestrians, changes in weather, changes in driver during a trip, etc.). In embodiments, the developer of the vehicle 202, the operator of the vehicle 202, the developer of the driver assistance system 224, the developer of the autonomous driving handoff system 226, or a combination may adjust weighting and/or adjustment of factors used for determining current functional load experienced by driver-assistance system 224. Furthermore, processing resources may also be accounted for in the measured current functional load. That is, for example, a faster processor will be able to process more tasks than a slower processor, and in embodiments, autonomous driving handoff system 226 accounts for the different processing capabilities by adjusting the overall measure of functional load, such as utilizing of percentage of total load experienced regardless of specific processor capabilities, access to total number of concurrent tasks capable of being performed by processing resources, etc.

In one embodiment, autonomous driving handoff system 226 establishes one or more thresholds to, for example, generate alerts, warnings, and/or remediative actions based on the measure of current function load placed by driver-assistance system 224 on available processing resources (e.g., on processor(s) 212 and memory 205). In embodiments, the thresholds may be set by the autonomous driving handoff system 226, the driver-assistance system 224, and/or adjusted based on driving characteristics of the vehicle (e.g., current weather being experienced, driver profile (experienced, new, professional, etc.), current traffic conditions, vehicle type, etc.). As discussed herein, the thresholds are associated with different current functional loads of driver-assistance system 224. For example, in an embodiment, a first threshold may be associated with a first functional load that, when satisfied by the measured current functional load, would indicate that an alert be issued to an operator of vehicle 202 that future circumstances may require them to take over control of vehicle from driver-assistance system 224. A second threshold may then be associated with a second, greater functional load that, when satisfied by the measured current functional load, would indicate that a warning be issued to an operator of vehicle 202 that imminent or immediate operator intervention is required to take over control of vehicle from driver-assistance system 224. In one embodiment, autonomous driving handoff system 226 generates alerts and/or warnings when the one or more thresholds are satisfied, and provides the alerts and/or warnings to user interfaces(s) 242 for presentation to an operator of vehicle. As discussed herein those user interface(s) 242 include, for example, one or more graphical user interfaces rendered on a vehicle display, a haptic feedback system, an audio system that generates chimes, tones, speech, or other alerts and/or warnings, as well as other user interface systems. In embodiments, in response to one or more of the thresholds being satisfied, autonomous driving handoff system 226 may optionally generate and sent driver-assistance system 226 a message indicating the factors used to determine the functional load threshold. These factors, in embodiments, enable driver-assistance system 224 to take one or more actions based on the factors leading to the satisfaction of the functional load threshold to, for example, adjust driving mode(s), slow a vehicle, add more space between vehicles, pull over, etc. until the thresholds are no longer satisfied and/or a vehicle operator takes action(s) that lower the current function load placed on driver-assistance system 224.

Furthermore, in an embodiment, an additional threshold and/or the first and second thresholds, may be associated with adjustments that autonomous driving handoff system 226 makes to the control and operation of vehicle 202. For example, the adjustments can include adjustments to settings of the driver-assistance system's 224 autonomous control of vehicle 202, adjustments to settings of one or more of the automated driving system controller(s) 228 to control emergency braking (e.g., extends a boundary in which emergency braking is triggered), lane assistance systems (e.g., reduces the distance from a center of a lane required to trigger lane assistance features), parking systems (e.g., extends boundary to obstacles detected in a trajectory of vehicle 202 parking), etc., as well as other adjustments. Thus, autonomous driving handoff system 226 may not only generate alerts and warnings issued to a vehicle operator, but can adjust autonomous driving and other vehicle systems to account for a current functional load indicating increased complexity of a current operational environment.

Autonomous driving handoff system 226 further monitors the systems utilized by driver-assistance system 224 for additional health factors related to proper operation of those systems. For example, autonomous driving handoff system 226 may monitor LIDAR 230-2, positioning system 230-N, processor 212, etc. to determine whether they are operating within expected parameters (e.g., system messaging occurring as normal, coherency between operations/measurements, data types being communicated are as expected, etc.). In embodiments, measurement values, frequency of messaging, message formatting, payload size, etc. are dependent on the specific system being monitored. For example, although LIDAR 230-2 and RADAR 230-3 both perform ranging imaging and measurements, each system captures different data, may capture the data at a different frequency, manufacturer(s) of the LIDAR and RADAR systems may use different messaging protocols, etc. Therefore, the data generated by such systems are each associated with their own expected operational parameters, which have an expected range of values, format, data type, frequency, etc. In embodiments, autonomous driving handoff system 226 may be configured with the operational parameters of each system to be monitored (e.g., each of camera(s) 230-1 though positioning system 230-N, a combination of systems identified as critical to the driver-assistance system 224, etc.) within vehicle 202, may receive the operational parameters from the driver-assistance system 224 in an API based message, or a combination. In embodiments, autonomous driving handoff system 226 monitors the operational parameters of one or more of these vehicle systems as a check against the functional load determinations, such as when a system is not acting properly or within expected norms (e.g., at least one of the monitored operational parameter(s) does not satisfy an expected value, non-linear changes in values are detected over a period of time, messaging frequency is above or below an expected frequency, etc.), but does not necessarily increase functional load. In embodiments, autonomous driving handoff system 226 may monitor one or more of a moving average of the values provided by each system (e.g. sensor values, images, etc.), a message format, a messaging frequency, etc. to detect significant variation in reported values or no variation in reported values (e.g., based on the moving average), problems with messaging format, errors in frequency of messaging (e.g., too frequent or not frequent enough), etc. In embodiments, satisfaction of one or more of these factors may be indicative of a malfunction or failure of a vehicle system, which is reportable to the driver-assistance system 224 for notification, warning, or remediation purposes, as discussed herein.

FIG. 2B is block diagram of another embodiment of a system 280 including a vehicle 202 for performing autonomous driving handoff warning and remediation. In the embodiment illustrated in FIG. 2B, autonomous driving handoff processing system 285 is a computer processing system (e.g. having its own network interface, memory, processing resources, etc.) communicatively coupled with sensor(s) 230 and VCU 206 over communications bus 107. In this embodiment, autonomous driving handoff processing system 285 performs the same functional load determination, alerting, warning, and additional system monitoring as discussed herein, but performs them using its own processing resources (e.g., processor(s), memory, operating system, etc.). In embodiments, autonomous driving handoff processing system 285 is embodied in its own processing system to provide isolation and/or protection from VCU systems 205 going down or otherwise operating abnormally. Furthermore, in embodiments, autonomous driving handoff processing system 285 listens to messaging between sensor(s) 230 and VCU 206 to detect additional factors (e.g. system health of various systems utilized for autonomous driving), and further interfaces with VCU 206 to monitor functional load, as discussed herein.

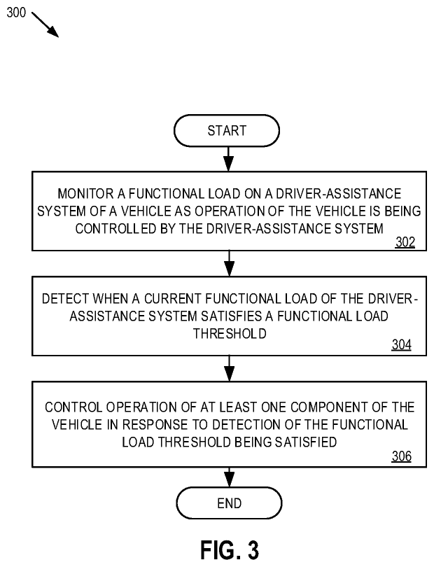

FIG. 3 is a flow diagram of one embodiment of a method 300 for performing autonomous driving handoff warning and remediation. The method 300 is performed by processing logic that may comprise hardware (circuitry, dedicated logic, etc.), software (such as is run on a general purpose computer system or a dedicated machine), firmware, or a combination. In one embodiment, the method 300 is performed by an autonomous driving handoff system of a vehicle (e.g., autonomous driving handoff system 126, 226, and/or 285 of vehicle 102 and/or 202).

Referring to FIG. 3, processing logic begins by monitoring a functional load on a driver-assistance system of a vehicle as autonomous operation of the vehicle is being controlled by the driver-assistance system (processing block 302). As discussed herein, the vehicle may be an autonomous fully or semi electric car, which is being autonomously driven on a roadway. Thus, the driver-assistance system performs autonomous driving operations (e.g., object detection, recognition, tracking, predictions, controlling acceleration, speed, braking, and navigation, etc.) that enable the control of the vehicle without input from an operator. Thus, processing logic monitors the tasks, such as computational tasks, thread, etc., being performed by the driver-assistance system to effectuate the autonomous control of the vehicle. In embodiments, a functional load may be determined as a total of the number of tasks being performed by the driver-assistance system. In another embodiment, the individual tasks may be weighted according to task type, operational conditions, driver conditions, etc. before being summed in the total number of tasks.

Processing logic then detects when a current functional load of the driver-assistance system satisfies a functional load threshold (processing block 304). In embodiments, the functional load is a dynamic value that fluctuates based on the operational conditions experienced by the vehicle and as determined by driver-assistance system. Thus, the current functional load, which corresponds to a real time or near real time measure of a complexity of the current operational environment of the vehicle, is continuously determined by processing logic and compared against a functional load threshold. As discussed herein, the functional load threshold may include more than one threshold that are each associated with different alert(s), warning(s), and remediative action(s) to inform an operator that future conditions could require the operator to intervene and take over operation of the vehicle from the driver-assistance system, to inform an operator that imminent and/or current conditions require the driver to intervene and take over operation of the vehicle from the driver-assistance system, and adjust current operation of the vehicle by adjusting settings of the driver-assistance system and/or one or more automated driving system controllers. Furthermore, different functional load thresholds may be used by processing logic. For example, environmental condition specific thresholds (e.g., where operational conditions (e.g., low light, rain, etc.) imply that different thresholds are desirable to provide earlier alerts, warnings, and/or remediative actions), driver specific thresholds (e.g., where differences in experience, safety record, etc. can be used to adjust how early alerts, warning, and/or remediative actions are taken), processing resource availability thresholds (e.g. adjustment of thresholds based on type of processor, available memory, multithreaded or non-multithreaded execution environment, etc.), as well as other threshold adjustments.

Processing logic then controls operation of at least one component of the vehicle in response to detection of the functional load threshold being satisfied (processing block 306). In an embodiment, the at least one component includes a user interface element (e.g., a visual display, an audio system, a haptic feedback system, etc.) in which the user is informed of the future or immediate need to intervene and take over operation of the vehicle. In another embodiment, the at least one component includes the driver-assistance system, and the control adjusts how the driver-assistance system is autonomously controlling operation of the vehicle. In yet another embodiment, the at least one component includes an automated vehicle system, such as a breaking, acceleration, warning, or other system, and the control commands an operation be performed by that system.

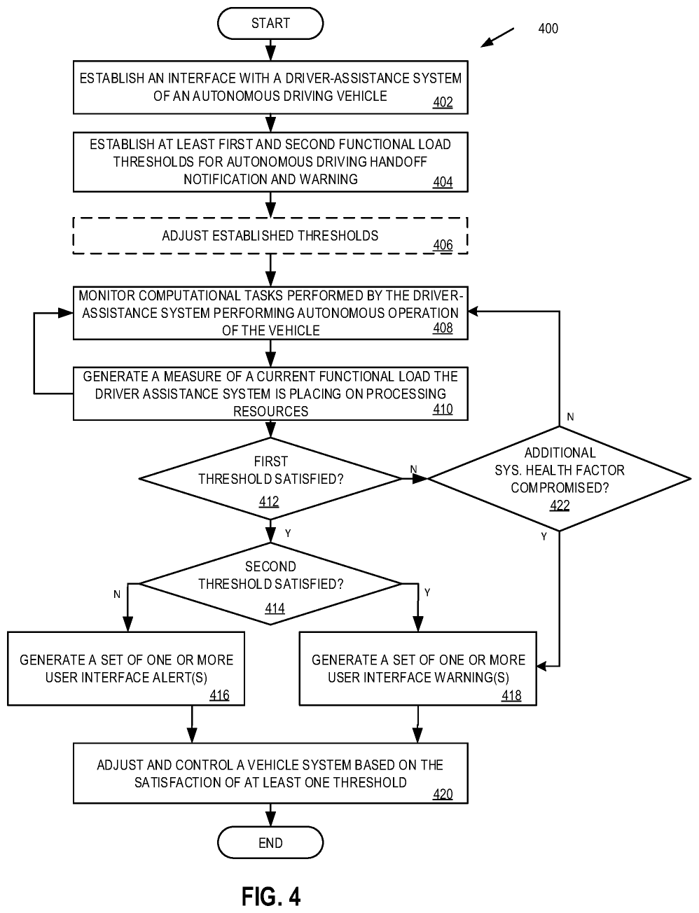

FIG. 4 is a flow diagram of another embodiment of a method 400 for performing autonomous driving handoff warning and remediation. The method 400 is performed by processing logic that may comprise hardware (circuitry, dedicated logic, etc.), software (such as is run on a general purpose computer system or a dedicated machine), firmware, or a combination. In one embodiment, the method 400 is performed by an autonomous driving handoff system of a vehicle (e.g., autonomous driving handoff system 126, 226, and/or 285 of vehicle 102 and/or 202).

Referring to FIG. 4, processing logic begins by establishing an interface with a driver-assistance system of an autonomous driving vehicle (processing block 402). As discussed herein, in embodiments, processing logic for performing autonomous driving handoff warning and remediation may establish an interface with the driver-assistance system via a set of APIs of the driver-assistance system that expose certain functions, such as task monitoring, task reporting, inclusion of task description data, etc., of the driver-assistance system to other systems of an autonomous vehicle. In other embodiments, processing logic may be integrated into the driver-assistance system. In either embodiment, by establishing the interface, processing logic is able to monitor and measure a functional load placed on processing resources of an autonomous vehicle that are available to the driver-assistance system, such as VCU resources, resources of a dedicated processing system, etc.

Processing logic then establishes at least first and second functional load thresholds for autonomous driving handoff alert and warning (processing block 404). As discussed herein, these established functional load thresholds correspond to different levels or amounts of processing resource utilization as measured by functional load placed on those resources. For example, each functional load threshold may represent a percentage of total processing resource utilization, a number of tasks being performed by the driver-assistance system, as well as other measures of functional load exerted by the driver-assistance system on available processing resources. Any number and associated values of functional load thresholds may be used in accordance with the discussion herein for generating alerts, warnings, remediative actions, or other actions.

In some embodiments, processing system may optionally adjust one or more of the established thresholds (processing block 406). For example, based on driver/operator factors (e.g., age, experience, driving record, tracked sensed reaction times, tracked prior responses to alerts and/or warnings, etc.), environmental factors (e.g., light condition, weather condition, resolution of available map data, correlation of map data to sensed roadway data, etc.), processing resource factors (e.g., processor type, processor speed, whether the processor is dedicated to the driver-assistance system, multi-threaded processing capabilities, memory availability, memory speed, etc.), operational factors (e.g., presence of non-presence of pedestrians, highway operation or non-highway operation, etc.), as well as other factors. In embodiments, based on one or more of the factors noted above as well as other factors that may be relevant to driver intervention when autonomous vehicle is operating in an autonomous mode, the thresholds may be adjusted, independently of one another, up or down to increase or decrease the threshold relative to processing resource utilization. By adjusting the thresholds, the time to alert and/or warning can be decreased (e.g., alerts and/or warnings given earlier), increased (e.g., alerts and/or warnings given later), or a combination of increasing and decreasing the thresholds. Furthermore, the adjustment of thresholds may be dynamic such that the thresholds continuously or periodically adjust based on one or more of the factors discussed above.

Processing logic then monitors computational tasks performed by the driver-assistance system performing autonomous operation of the vehicle (processing block 408). As discussed above, the driver-assistance system will ingest sensor data captured by a plurality of vehicle sensor systems. From this sensor data, the driver assistance system will model and continuously update the operational environment in real time or near real time. For example, each object within the operational environment may be located, identified/recognized, and movements tracked. Therefore, as the identification and tracking of the number of objects grows or shrinks, so does the number of computational tasks being performed by the driver-assistance system.

Processing logic therefore uses the number of computational tasks to generate a measure of functional load the driver-assistance system is placing on processing resources (processing block 410). The functional load is an indicator of complexity of operational environment, where it may be appropriate for an operator to take over control, or be prepared to take over control, of operation of the motor vehicle because the driver-assistance system may not be able to appropriately autonomously respond to the demands of the operational environment.

When processing logic determines that the first functional load threshold is not satisfied (processing block 408), processing logic additionally checks whether additional system health factor(s) have been compromised (processing block 422). For example, a sensor system may be compromised when an abnormality (e.g., lack of communication, lack of data coherency, etc.) associated with the sensor system is detected. When they have not, for example systems such as the VCU, LIDAR, imaging systems, positioning systems, etc. are determined to be functioning as expected, processing logic returns to processing block 408 to continue monitoring the computational tasks. When system(s) are determined to have been compromised, processing logic advances processing block 418, as discussed below. Furthermore, in embodiments, the monitoring and determination that systems of the vehicle are functioning as expected may operate in parallel and independently of the functional load determination of processing blocks 410-414.

In an embodiment, processing logic then determines if a first functional load threshold is satisfied (processing block 412), and if so whether a second functional load threshold is satisfied (processing block 414). In embodiment, the first functional load threshold is indicative of less of a functional load placed on processing resource by the driver-assistance system than the second functional load threshold. When the second functional load threshold is not satisfied (e.g., only the first threshold is satisfied), processing logic generates a set of one or more user interface alert(s) to the operator of the autonomous vehicle (processing block 416). When the first and second thresholds are satisfied, processing logic generates a set of one or more user interface warning(s) to the operator of the autonomous vehicle (processing block 418). In embodiments, the user interface alert(s) (e.g., GUI notifications, sound notifications, haptic notifications, etc.) are indicative of a developing condition in which it may become necessary at some point in the future for the operator of the autonomous vehicle to take over control from the driver-assistance system. Relatedly, the user interface warning(s) are indicative of a developing condition in which it may become necessary at some point in the future for the operator of the autonomous vehicle to take over control from the driver-assistance system. Furthermore, warnings based on compromised system(s) of vehicle may also indicate an imminent need for a driver to retain control of vehicle from an autonomous driving system. Thus, less intense and/or forceful set of user interface notifications are provided to the operator of the autonomous vehicle when the first functional load threshold is satisfied, and more intense and/or forceful user interface notifications are provided to the operator of the autonomous vehicle when the second functional load threshold is satisfied. For example, an alert may include a sound played through a vehicle audio system at a first volume and having a first tone, while a warning may include a louder and/or different sound played through the vehicle audio system at a second volume. As another example, an alert may include information about a developing condition displayed on a display panel of the vehicle at a first display position and/or a first size, while a warning may include instructions to take over control of operation of the vehicle immediately displayed larger or at a more prominent location on the display panel. As yet another example, a haptic alert may include vibrating a steering wheel, seat, etc. at a first intensity, frequency, and/or pattern, while a haptic warning may include vibrating the steering wheel, seat, etc. at a second intensity, frequency, and/or pattern. Furthermore, more than one user interface feedback system may be used for each of the alert and/or warnings.

Processing logic then adjusts and controls the autonomous vehicle based on satisfaction of at least one threshold (processing block 420). As discussed in greater detail above, the adjustment and/or control can include commanding the driver-assistance system, for example when the first threshold is satisfied, to place operation in more cautious mode (e.g., slow speed, increase room between nearby vehicles, etc.), to re-route the autonomous vehicle (e.g., change driving lanes, exit a roadway), etc. Similarly, the adjustment and/or control can include commanding the driver-assistance system, for example when the second threshold is satisfied, to pull vehicle off road and come to a stop. The adjustment and/or control can also include commanding one or more automated driving system controllers, such as brake assist controllers, lane maintenance system controllers, cruise control controllers, etc. to account for a potential future or imminent condition.

In the embodiments discussed herein, while a vehicle is operating autonomously, alerts, warnings, and remediation may per pursued to account for developing conditions in an operational environment of the vehicle. The determination of when to take such remediate actions to effectuate control of operation of the vehicle, when to issue alerts, and when to issue warnings may be based, at least in part, on the functional load placed on processing resources available to the driver-assistance system perform the autonomous operations. The usage of processing load, instead of or in addition to driver-assistance system recognition of specific circumstances, enables the techniques discussed herein to be carried out more efficiently (e.g., with respect to utilization of processing and memory resources) within an autonomous vehicle, and without training a driver-assistance system to recognize specific and variable circumstances (e.g., not reliant on pre-training for specific operational environment scenarios), to improve when and how alerts, warnings, and remediative actions occur during autonomous operation of a vehicle. Furthermore, the techniques discussed herein make non-conventional usage of processing resource utilization to determine when to issue alerts, warnings, and take remediative actions for handoff of a vehicle from an autonomous driving mode of operation to an operator controlled mode of operation.

The following examples pertain to further embodiments of the inventions discussed herein.

Example 1 pertains to an autonomous vehicle. The autonomous vehicle can include a memory, at least one component, and a processor coupled with the memory and the component. The processor can monitor a functional load of a driver-assistance system of the autonomous vehicle as operation of the autonomous vehicle is being controlled by the driver-assistance system. Furthermore, the processor can detect when a current function load of the driver-assistance system satisfies a functional load threshold. Additionally, the processor can control operation of at least one component of the autonomous vehicle in response to detection of the functional load threshold being satisfied.

In Example 2, the subject matter of Example 1 can optionally include a plurality of sensor systems comprising a radio detection and ranging (RADAR) system, a light detection and ranging (LIDAR) system, a positioning system, a camera system, or a combination thereof. Furthermore, the driver-assistance system controls the autonomous vehicle based, at least in part, on a plurality of inputs from the plurality of sensor systems.

In Example 3, the subject matter of any of Examples 1-2 can optionally further include the processor configured to monitor the functional load on the driver-assistance system of the autonomous vehicle by detecting one or more computational tasks being performed by the driver-assistance system, wherein each task processes input from at least one sensor system to detect and/or track an object in a current operational environment of the autonomous vehicle. The processor can also generate a measure of a current function load based on the detected one or more computational tasks. Furthermore, the processor can determine when the function load threshold is satisfied based on the measure of the current function load. Additionally, the processor can initiate control of the at least one component of the autonomous vehicle in response to the determination that the function load threshold has been satisfied.

In Example 4, the subject matter of any of Examples 1-3 can optionally include a measure of each of the detected computation tasks being based on a computational complexity of a load placed on the driver-assistance system, a priority of the task to the driver-assistance system, a type of sensor that provides data as input to a task, or a combination thereof. Furthermore, generating the current measure of the current function load can further include summing individual measures of each the detected computation tasks.

In Example 5, the subjected matter of any of Examples 1-3 can optionally include the functional load threshold comprising a first functional load threshold and a second functional load threshold, the first functional load threshold being associated with a first measure of the current functional load and the second functional load threshold being associated with a second measure of the current function load. Furthermore, the second measure can be associated with a greater total computational complexity, and different types of operations of the at least one component of the autonomous vehicle is initiated when the first threshold is satisfied and when the second threshold is satisfied.

In Example 6, the subject matter of any of Examples 1-3 and 5 can optionally include the processor being configured to control operation of at least one component of the autonomous vehicle in response to detection that the first functional load threshold has been satisfied, where the processor is configured to generate a user interface alert, wherein the user interface alert comprise one or more of a graphical user interface alert, an audio alert, a haptic alert, or a combination thereof.

In Example 7, the subject matter of any of Examples 1-3 and 5-6 can optionally include the processor being configured to control operation of the least one component of the autonomous vehicle in response to detection that the second functional load threshold has been satisfied and the user interface alert has been generated, where the processor is configured to generate a user interface warning, Furthermore, the user interface warning can comprise one or more of a graphical user interface warning, an audio warning, a haptic warning, or a combination thereof, and feedback provided to an operator of the autonomous vehicle by the user interface warning is different than feedback provided by the user interface alert.

In Example 8, the subject matter of any of Examples 1-3 and 5-6 can optionally include the user interface alert comprising an alert about a developing safety condition within the operational environment of the autonomous vehicle, and the user interface warning comprising a notification to an operator of the autonomous vehicle of an imminent safety condition and instructions to take over control of operation of the autonomous vehicle from the driver-assistance system.

In Example 9, the subject matter of any of Examples 1-3 and 5 can optionally include the processor being configured to control operation of at least one component of the autonomous vehicle in response to detection that the first functional load threshold has been satisfied, includes the processor being configured to adjust a setting of a driver-assistance system, an automated driving system, or a combination thereof, and control the operation of the autonomous vehicle by the driver-assistance system based on the adjustment without intervention of an operator of the autonomous vehicle.

In Example 10, the subject matter of any of Examples 1-2 can optionally include the processor being configured to monitor one or more operational parameters of a sensor system of the autonomous vehicle used by the driver-assistance system, detect a compromise in operation of the sensor system based on at least one of the one or more operational parameters being monitored not having an expected value, and control operation of the at least one component of the autonomous vehicle in response to detection of the compromise.

In Example 11, the subject matter of any of Examples 1-2 and 10 can optionally include the compromise in the operation of the sensor system is detected without a detection that the current functional load satisfies the functional load threshold.

In Example 12, the subject matter of Example 1 can optionally include the autonomous vehicle being an electric vehicle.

All optional features of the autonomous vehicle described above may also be used in a method for operating an autonomous vehicle according to any combination of Examples 1-12 discussed above. Furthermore, all optional features of the autonomous vehicle described above may also be integrated into a non-transitory machine readable storage medium having instructions stored thereon, which when executed by a processing system of an autonomous vehicle, causes the processing system to perform one or more operations for operating the autonomous vehicle according to any combination of Examples 1-12 discussed above.

Furthermore, specifics in the examples above may be used anywhere in one or more embodiments.

Those of skill would appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software as a computer program product, the functions may be stored on or transmitted over as one or more instructions or code on a non-transitory computer-readable medium. Computer-readable media can include both computer storage media and communication media including any medium that facilitates transfer of a computer program from one place to another. A storage media may be any available media that can be accessed by a computer. By way of example, and not limitation, such non-transitory computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of non-transitory computer-readable media.

The previous description of the disclosed embodiments is provided to enable any person skilled in the art to make or use the methods, systems, and apparatus of the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. An autonomous vehicle, comprising:
a memory;
at least one component; and
a processor coupled with the memory and the component, the processor configured to:
monitor a functional load of a driver-assistance system of the autonomous vehicle as operation of the autonomous vehicle is being controlled by the driver-assistance system,
detect when a current function load of the driver-assistance system satisfies a functional load threshold, and
control operation of at least one component of the autonomous vehicle in response to detection of the functional load threshold being satisfied.

2. The autonomous vehicle of claim 1, wherein the autonomous vehicle further comprises:
a plurality of sensor systems comprising a radio detection and ranging (RADAR) system, a light detection and ranging (LIDAR) system, a positioning system, a camera system, or a combination thereof, wherein the driver-assistance system controls the autonomous vehicle based, at least in part, on a plurality of inputs from the plurality of sensor systems.

3. The autonomous vehicle of claim 2, wherein the processor configured to monitor the functional load on the driver-assistance system of the autonomous vehicle further comprises the processor configured to:
detect one or more computational tasks being performed by the driver-assistance system, wherein each task processes input from at least one sensor system to detect and/or track an object in a current operational environment of the autonomous vehicle,
generate a measure of a current function load based on the detected one or more computational tasks,
determine when the function load threshold is satisfied based on the measure of the current function load, and
initiate control of the at least one component of the autonomous vehicle in response to the determination that the function load threshold has been satisfied.

4. The autonomous vehicle of claim 3, wherein a measure of each of the detected computation tasks is based on a computational complexity of a load placed on the driver-assistance system, a priority of the task to the driver-assistance system, a type of sensor that provides data as input to a task, or a combination thereof, and wherein generating the current measure of the current function load comprises summing individual measures of each the detected computation tasks.

5. The autonomous vehicle of claim 3, wherein the functional load threshold comprise a first functional load threshold and a second functional load threshold, the first functional load threshold being associated with a first measure of the current functional load and the second functional load threshold being associated with a second measure of the current function load, wherein the second measure is associated with a greater total computational complexity, and wherein different types of operations of the at least one component of the autonomous vehicle is initiated when the first threshold is satisfied and when the second threshold is satisfied.

6. The autonomous vehicle of claim 5, wherein the processor configured to control operation of at least one component of the autonomous vehicle in response to detection that the first functional load threshold has been satisfied, comprises the processor configured to:
generate a user interface alert, wherein the user interface alert comprise one or more of a graphical user interface alert, an audio alert, a haptic alert, or a combination thereof.

7. The autonomous vehicle of claim 6, wherein the processor configured to control operation of the least one component of the autonomous vehicle in response to detection that the second functional load threshold has been satisfied and the user interface alert has been generated, comprises the processor configured to:
generate a user interface warning, wherein the user interface warning comprise one or more of a graphical user interface warning, an audio warning, a haptic warning, or a combination thereof, wherein feedback provided to an operator of the autonomous vehicle by the user interface warning is different than feedback provided by the user interface alert.

8. The autonomous vehicle of claim 6, wherein the user interface alert comprises an alert about a developing safety condition within the operational environment of the autonomous vehicle, and wherein the user interface warning comprises a notification to an operator of the autonomous vehicle of an imminent safety condition and instructions to take over control of operation of the autonomous vehicle from the driver-assistance system.

9. The autonomous vehicle of claim 5, wherein the processor configured to control operation of at least one component of the autonomous vehicle in response to detection that the first functional load threshold has been satisfied, comprises the processor configured to:
adjust a setting of a driver-assistance system, an automated driving system, or a combination thereof, and
control the operation of the autonomous vehicle by the driver-assistance system based on the adjustment without intervention of an operator of the autonomous vehicle.

10. The autonomous vehicle of claim 2, wherein the processor is further configured to:
monitor one or more operational parameters of a sensor system of the autonomous vehicle used by the driver-assistance system;
detect a compromise in operation of the sensor system based on at least one of the one or more operational parameters being monitored not having an expected value; and
control operation of the at least one component of the autonomous vehicle in response to detection of the compromise.

11. The method of claim 10, wherein the compromise in the operation of the sensor system is detected without a detection that the current functional load satisfies the functional load threshold.

12. The autonomous vehicle of claim 1, wherein the autonomous vehicle is an electric vehicle.

13. A method for operating an autonomous vehicle, the method comprising:
monitoring a functional load on a driver-assistance system of the autonomous vehicle as operation of the autonomous vehicle is being controlled by the driver-assistance system;
detecting when a current function load of the driver-assistance system satisfies a functional load threshold; and
controlling operation of at least one component of the autonomous vehicle in response to detection of the functional load threshold being satisfied.

14. The method of claim 13, wherein the driver-assistance system controls the autonomous vehicle based on a plurality of inputs from a plurality of sensor systems of the autonomous vehicle, wherein the plurality of sensor systems comprise a radio detection and ranging (RADAR) system, a light detection and ranging (LIDAR) system, a positioning system, a camera system, or a combination thereof.

15. The method of claim 14, wherein monitoring the functional load on the driver-assistance system of the autonomous vehicle further comprises:
detecting one or more computational tasks being performed by the driver-assistance system, wherein each task processes input from at least one sensor system to detect and/or track an object in a current operational environment of the autonomous vehicle;
generating a measure of a current function load based on the detected one or more computational tasks;
determining when the function load threshold is satisfied based on the measure of the current function load; and
initiating control of the at least one component of the autonomous vehicle in response to the determination that the function load threshold has been satisfied.

16. The method of claim 15, wherein a measure of each the detected computation tasks is based on a computational complexity of a load placed on the driver-assistance system, a priority of the task to the driver-assistance system, a type of sensor that provides data as input to a task, or a combination thereof, and wherein generating the current measure of the current function load comprises summing individual measures of each the detected computation tasks.

17. The method of claim 15, wherein the functional load threshold comprise a first functional load threshold and a second functional load threshold, the first functional load threshold being associated with a first measure of the current functional load and the second functional load threshold being associated with a second measure of the current function load, wherein the second measure is associated with a greater total computational complexity, and wherein different types of operations of the at least one component of the autonomous vehicle is initiated when the first threshold is satisfied and when the second threshold is satisfied.

18. The method of claim 17, wherein controlling operation of at least one component of the autonomous vehicle in response to detection that the first functional load threshold has been satisfied, comprises:
generating a user interface alert, wherein the user interface alert comprise one or more of a graphical user interface alert, an audio alert, a haptic alert, or a combination thereof.

19. The method of claim 18, wherein controlling operation of the least one component of the autonomous vehicle in response to detection that the second functional load threshold has been satisfied and the user interface alert has been generated, comprises:
generating a user interface warning, wherein the user interface warning comprise one or more of a graphical user interface warning, an audio warning, a haptic warning, or a combination thereof, wherein feedback provided to an operator of the autonomous vehicle by the user interface warning is different than feedback provided by the user interface alert.

20. The method of claim 18, wherein the user interface alert comprises an alert about a developing safety condition within the operational environment of the autonomous vehicle, and wherein the user interface warning comprises a notification to an operator of the autonomous vehicle of an imminent safety condition and instructions to take over control of operation of the autonomous vehicle from the driver-assistance system.

21. The method of claim 17, wherein controlling operation of at least one component of the autonomous vehicle in response to detection that the first functional load threshold has been satisfied, comprises:
adjusting a setting of a driver-assistance system, an automated driving system, or a combination thereof; and
controlling the operation of the autonomous vehicle by the driver-assistance system based on the adjustment without intervention of an operator of the autonomous vehicle.

22. The method of claim 13, wherein the autonomous vehicle is an electric vehicle.

23. A non-transitory machine readable storage medium having instructions stored thereon, which when executed by a processing system of an autonomous vehicle, causes the processing system to perform one or more operations for operating the autonomous vehicle, the one or more operations comprising
monitoring a functional load on a driver-assistance system of the autonomous vehicle as operation of the autonomous vehicle is being controlled by the driver-assistance system;
detecting when a current function load of the driver-assistance system satisfies a functional load threshold; and
controlling operation of at least one component of the autonomous vehicle in response to detection of the functional load threshold being satisfied.

24. The non-transitory machine readable storage medium of claim 23, wherein the driver-assistance system controls the autonomous vehicle based on a plurality of inputs from a plurality of sensor systems of the autonomous vehicle, wherein the plurality of sensor systems comprise a radio detection and ranging (RADAR) system, a light detection and ranging (LIDAR) system, a positioning system, a camera system, or a combination thereof.

25. The non-transitory machine readable storage medium of claim 24, wherein operations for monitoring the functional load on the driver-assistance system of the autonomous vehicle further comprises operations for:
detecting one or more computational tasks being performed by the driver-assistance system, wherein each task processes input from at least one sensor system to detect and/or track an object in a current operational environment of the autonomous vehicle;
generating a measure of a current function load based on the detected one or more computational tasks;
determining when the function load threshold is satisfied based on the measure of the current function load; and
initiating control of the at least one component of the autonomous vehicle in response to the determination that the function load threshold has been satisfied.

26. The non-transitory machine readable storage medium of claim 25, wherein a measure of each the detected computation tasks is based on a computational complexity of a load placed on the driver-assistance system, a priority of the task to the driver-assistance system, a type of sensor that provides data as input to a task, or a combination thereof, and wherein generating the current measure of the current function load comprises summing individual measures of each the detected computation tasks.

27. The non-transitory machine readable storage medium of claim 25, wherein the functional load threshold comprise a first functional load threshold and a second functional load threshold, the first functional load threshold being associated with a first measure of the current functional load and the second functional load threshold being associated with a second measure of the current function load, wherein the second measure is associated with a greater total computational complexity, and wherein different types of operations of the at least one component of the autonomous vehicle is initiated when the first threshold is satisfied and when the second threshold is satisfied.

28. The non-transitory machine readable storage medium of claim 27, wherein operations for controlling operation of at least one component of the autonomous vehicle in response to detection that the first functional load threshold has been satisfied, comprise operations for:
adjusting a setting of a driver-assistance system, an automated driving system, or a combination thereof; and
controlling the operation of the autonomous vehicle by the driver-assistance system based on the adjustment without intervention of an operator of the autonomous vehicle.
